(19) United States
(12) Patent Application Publication
(10) Pub. No.: US 2024/0157962 A1
(43) Pub. Date: May 16, 2024

(54) VEHICLE SENSOR RELATIVE ALIGNMENT VERIFICATION

(71) Applicant: Argo AI, LLC, Pittsburgh, PA (US)

(72) Inventor: Casey James SENNOTT, Pittsburgh, PA (US)

(73) Assignee: Argo AI, LLC, Pittsburgh, PA (US)

(21) Appl. No.: 17/988,344

(22) Filed: Nov. 16, 2022

(51) Int. Cl. B60W 60/00; G06T 7/20; G06T 7/70

(52) U.S. Cl. CPC B60W 60/001; G06T 7/20; G06T 7/70; B60W 2050/0075; B60W 2420/42; B60W 2420/52

(57) ABSTRACT

Disclosed herein are system, method, and computer readable medium embodiments for sensor relative alignment verification. The vehicle system includes a sensor configured to capture range data with a body defining a sensor coordinate frame with three axes. At least three first motion sensors are coupled to the body, each being configured to capture first motion data along a first sensor axis arranged non-orthogonally relative to the first axis and the second axis, wherein the first motion data is indicative of a first rotational degree of freedom about the first axis, and a second rotational degree of freedom about the second axis. At least two second motion sensors are coupled to the body, each being configured to capture second motion data along a second sensor axis arranged non-orthogonally relative to the third axis, wherein the second motion data is indicative of a third rotational degree of freedom about the third axis.

### TECHNICAL FIELD

Aspects disclosed herein generally relate to a system and method for verifying the relative alignment of vehicle sensors using motion sensors.

### BACKGROUND

A vehicle system may monitor an environment external to a vehicle for obstacle detection and avoidance. The vehicle system may include multiple sensor assemblies for monitoring objects proximate to the vehicle in the near-field and distant objects in the far-field. Each sensor assembly may include one or more sensors, such as a camera, a radio detection and ranging (radar) sensor, a light detection and ranging (lidar) sensor, an infrared sensor, an ultrasonic sensor, and a microphone. A lidar sensor includes one or more emitters for transmitting light pulses away from the vehicle, and one or more detectors for receiving and analyzing reflected light pulses. The vehicle system may determine the location of objects in the external environment based on data from the sensors, and control one or more systems, e.g., a powertrain, braking systems, and steering systems based on the locations of the objects.

The performance of the vehicle system depends on the accuracy of the data collected by the sensors. However, misaligned sensors may capture unreliable data. Therefore, there is a need to enhance the proper orientation of sensors to ensure that the captured data does not undermine the performance of the vehicle system.

### SUMMARY

In one embodiment a vehicle system is provided with a sensor that includes a body. The sensor being configured to capture range data indicative of a distance between the sensor and an object external to a vehicle, the body defining a sensor coordinate frame comprising a first axis, a second axis, and a third axis arranged orthogonally relative to each other. At least three first motion sensors ae coupled to the body. Each first motion sensor is configured to capture first motion data along a first sensor axis. The first sensor axis is arranged non-orthogonally relative to the first axis and the second axis, wherein the first motion data is indicative of a first rotational degree of freedom about the first axis and a second rotational degree of freedom about the second axis. At least two second motion sensors are coupled to the body. Each second motion sensor is configured to capture second motion data along a second sensor axis. The second sensor axis is arranged non-orthogonally relative to the third axis, wherein the second motion data is indicative of a third rotational degree of freedom about the third axis.

In another embodiment, a computer implemented method for controlling a vehicle system is provided. Range data is captured by a sensor, wherein the sensor defines a sensor coordinate frame with a first axis, a second axis, and a third axis arranged orthogonally relative to each other. First motion data is captured along at least one first sensor axis arranged non-orthogonally relative to the first axis and the second axis. Second motion data is captured along at least one second sensor axis arranged non-orthogonally relative to the third axis. An alignment of the sensor relative to a vehicle coordinate frame is determined based on the first motion data and the second motion data. Calibration data for the sensor to align the sensor coordinate frame with the vehicle coordinate frame is determined. The range data is adjusted based on the calibration data. At least one of a propulsion system, a steering system, and a braking system of the vehicle is controlled based on the adjusted range data.

In yet another embodiment, a non-transitory computer readable medium including computer-executable instructions stored thereon, which when executed by one or more processors, cause the one or more processors to perform operations is provided.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings.

FIG. 1 depicts a system as positioned on a vehicle for verifying a relative alignment of at least one vehicle sensor in accordance with aspects of the disclosure.

FIG. 2 is a schematic diagram illustrating an exemplary architecture of the vehicle system of FIG. 1, in accordance with aspects of the disclosure.

FIG. 3 is a diagram illustrating an exemplary architecture of a lidar sensor of the vehicle system of FIG. 2, in accordance with aspects of the disclosure.

FIG. 4 is a diagram illustrating the vehicle sensor equipped with multiple motion sensors, in accordance with aspects of the disclosure.

FIG. 5 is a diagram illustrating the vehicle sensor equipped with multiple spaced apart motion sensors, in accordance with aspects of the disclosure.

FIG. 6 is a flow chart illustrating a method for verifying the relative alignment of the vehicle sensor in accordance with aspects of the disclosure.

FIG. 7 is a flow chart illustrating a method for controlling an autonomous vehicle based on the verified vehicle sensor relative alignment.

FIG. 8 is a detailed schematic diagram of an example computer system for implementing various embodiments, in accordance with aspects of the disclosure.

### DETAILED DESCRIPTION

As required, detailed embodiments are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Vehicle sensors may be mounted at multiple different locations on a vehicle and aligned relative to a common vehicle location to correlate test data. Accordingly, the alignment of the vehicle sensors relative to this common vehicle location is verified by calibration to ensure that the captured data does not undermine the performance of the vehicle system. Calibration is used to minimize errors and distortions from the sensor data, and to root the sensor measurements into a frame or common location that is meaningful to the system. A calibration method refers to a process that determines a mathematical relationship to adjust data from its given domain or form into a desired domain. This relationship may be provided in the form of a transformation matrix involving rotations, translations, scaling, and skewing.

Vehicle sensors may be calibrated intrinsically by a manufacturer prior to shipment. Intrinsic calibration refers to a determination of how data is distorted or offset with respect to the coordinate frame of the sensor body itself in Euclidean space, typically considered a Cartesian frame, or what static errors it may incur. However, vehicle sensors, when mounted to the vehicle, may experience forces or rotational displacement due to their interaction with the vehicle body that impact the relative alignment and overall accuracy of the vehicle sensor. Accordingly, extrinsic calibration is used to understand various aspects of the vehicle sensors when mounted to a vehicle body. Extrinsic calibration refers to the measurement or estimation of the rotational and translational offsets between the sensor Cartesian frame and another, known Cartesian frame. Calibration transforms are most often expected to be static, and as such they are usually defined between two objects on the same rigid body.

Existing strategies for evaluating the relative alignment of a vehicle sensor under test focus on stationary testing in a lab, not dynamic vehicle testing during field or road testing. Such strategies typically involve sensors that are positioned external to the vehicle and therefore would not work if the vehicle is in motion at a test facility or in the field. In addition, strategies that rely on devices that provide a single point measurement (e.g., which are generally typical for other forms of mechanical testing) may not provide relative rotational information at the precision required to assess the relative alignment of the vehicle sensor.

Embodiments set forth herein generally provide, among other things, an array of motion sensors, such as accelerometers, that are installed on a vehicle sensor. The vehicle sensor may be used in connection with an autonomous vehicle (AV) and may include a light detection and ranging (LiDAR) sensor, a radar sensor, a camera, a video imaging system, etc. The motion sensors may be positioned on the vehicle sensor at predetermined locations to capture motion data associated with five or six degrees of freedom, for example, three rotational degrees of freedom and at least two translational degrees of freedom. The motion sensors may collect motion data during field and laboratory testing in static and dynamic conditions. Unlike existing systems, the array of motion sensors may be operated in a variety of conditions and may allow rotational displacement requirements to be verified during field operation.

In general, the motion sensors may capture, for example, three rotational degrees of freedom and at least two translation degrees of freedom of the vehicle sensor. The vehicle sensor behaves or serves as a rigid body during the test. Additional structures may be added to the vehicle sensor to improve a signal to noise ratio of the motion data provided by the motion sensors. For example, the motions sensors may be positioned on posts that extend away from a body of the vehicle sensor. The posts locate the motion sensors away from a center of rotation of the vehicle sensor to adjust the resonant frequency at least one octave above a bandwidth of interest for a given test.

The motion sensors (e.g., accelerometers) provide motion data that may be processed via a signal processing apparatus. The motion data collected from the motion sensors positioned on the vehicle sensor generally enable a direct extraction of acceleration of the body (e.g., vehicle sensor). The vehicle system may numerically integrate the motion data in a time domain or frequency domain to yield velocity and displacement. The vehicle system then analyzes the displacement to verify a relative alignment of the vehicle sensor and calibrate the vehicle sensor. The vehicle system then controls one or more aspects of the AV based on calibrated vehicle sensor data.

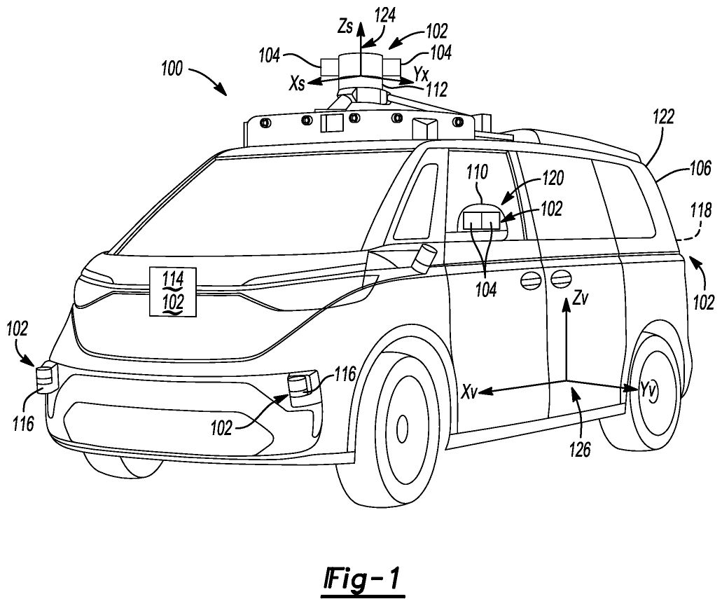

FIG. 1 depicts a vehicle system 100 for verifying the relative alignment of at least one vehicle sensor 102 in accordance with aspects of the disclosure. The vehicle system 100 includes an array of motion sensors 104 that are mounted to each vehicle sensor 102 to capture motion data relative to at least five degrees of freedom about the vehicle sensor 102. The vehicle system 100 is integrated with a vehicle, such as an autonomous vehicle (AV) 106. The vehicle sensors 102 are range sensors that monitor a field-of-view (FoV) about the vehicle 106 in accordance with aspects of the disclosure.

The vehicle system 100 includes multiple vehicle sensor assemblies to collectively monitor a 360-degree FoV around the AV 106 in the near-field and the far-field. The vehicle system 100 includes at least one side-sensor assembly 110, a top-sensor assembly 112, a front central sensor assembly 114, two front-side sensor assemblies 116, and one or more rear sensor assemblies 118, according to aspects of the disclosure. Each of the sensor assemblies 110, 112, 114, 116, and 118 include one or more vehicle sensors 102 that provide range data that is indicative of a distance between the vehicle sensor and one or more objects within its FoV. It is recognized that the vehicle sensor 102 may be, but is not limited to, a camera, a lidar sensor, a radar sensor, an infra-red sensor, an ultrasonic sensor, etc.

Each side sensor assembly 110 is mounted to a side of the vehicle 106, for example, to a side-view mirror 120 or front fender. Each side sensor assembly 110 includes multiple vehicle sensors 102, such as, a lidar sensor and a camera to monitor a FoV adjacent to the vehicle 106 in the near-field. The top sensor assembly 112 is mounted to a roof of the vehicle 106 and includes multiple vehicle sensors 102, such as one or more lidar sensors and cameras. The front sensor assemblies 116 are mounted to a front of the vehicle 106, such as, adjacent to the headlights. Each front sensor assembly 116 includes multiple vehicle sensors 102, for example, a lidar sensor, a radar sensor, and a camera to monitor a FoV in front of the vehicle 106 in the far-field. The rear-sensor assembly 118 is mounted to an upper rear portion of the vehicle 106, such as adjacent to a Center High Mount Stop Lamp (CHMSL). The rear-sensor assembly 118 also includes multiple vehicle sensors 102, such as a camera and a lidar sensor for monitoring the FoV behind the vehicle 106.

The vehicle sensors 102 may experience forces due to their interaction with a body 122 of the vehicle 106. These forces may impact the alignment of each vehicle sensor 102 relative to the vehicle body 122 and adversely impact the overall accuracy of the range data provided by the vehicle sensor 102. Accordingly, the vehicle system 100 analyzes the motion data to determine the displacement present at multiple locations of each vehicle sensor 102 due to the forces. A coordinate frame may be established for each vehicle sensor 102 and for the vehicle body 122 for the purpose of extrinsically calibrating the alignment of the vehicle sensor 102 relative to the vehicle body 122. For example, a sensor coordinate frame 124 is established at a center point of the vehicle sensor 102 that is located in the top sensor assembly 112. The sensor coordinate frame 124 includes three Axes: Xs, Ys, and Zs that are arranged orthogonally relative to each other. Similarly, a vehicle coordinate frame 126 is established for the vehicle body 122 at a central position of a rear axle of the vehicle 106. The vehicle coordinate frame 126 includes three Axes: Xv, Yv, and Zv that are arranged orthogonally relative to each other. The vehicle system 100 evaluates the motion data relative to the sensor coordinate frame 124 and the vehicle coordinate frame 126 to verify the relative alignment of the vehicle sensor 102 during field and laboratory testing.

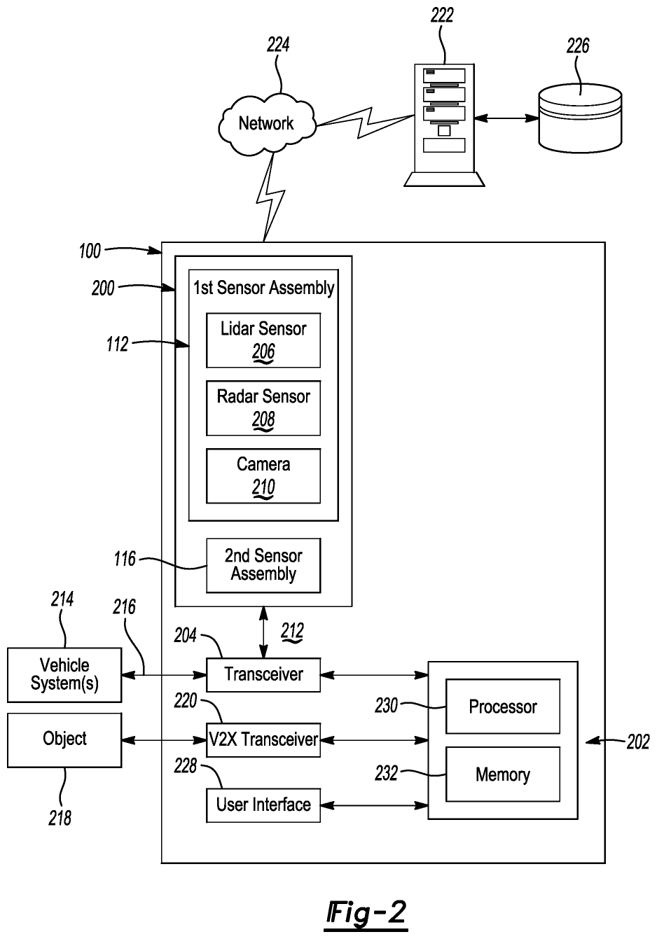

FIG. 2 illustrates communication between the vehicle system 100 and other systems and devices, according to aspects of the disclosure. The vehicle system 100 includes a sensor system 200 and a controller 202. The controller 202 may communicate with other systems and devices by wired or wireless communication through a transceiver 204. For example, the vehicle system 100 may receive range data from the sensor system 200 and provide calibrated range data to the other systems and devices.

The sensor system 200 includes the sensor assemblies, such as the top sensor assembly 112 and the front sensor assembly 116. The top sensor assembly 112 includes one or more range sensors, e.g., a lidar sensor 206, a radar sensor 208, and a camera 210. The camera 210 may be a visible spectrum camera, an infrared camera, etc., according to aspects of the disclosure. The sensor system 200 may include additional sensors, such as a microphone, a sound navigation and ranging (SONAR) sensor, temperature sensors, position sensors (e.g., global positioning system (GPS), etc.), location sensors, fuel sensors, motion sensors (e.g., inertial measurement units (IMU), accelerometers, etc.), humidity sensors, occupancy sensors, or the like. The sensor system 200 provides sensor data 212 that is indicative of the external environment of the AV 106. For example, the vehicle sensors 102 provide range data indicative of a distance between the vehicle sensor 102 and an object within its FoV. The controller 202 analyzes calibrated range data to identify and determine the location of external objects relative to the AV 106, e.g., the location of traffic lights, remote vehicles, pedestrians, etc.

The vehicle system 100 also communicates with one or more vehicle systems 214 through the transceiver 204, such as an engine, a transmission, a navigation system, and a braking system. The controller 202 may receive information from the vehicle systems 214 that is indicative of present operating conditions of the AV 106, such as vehicle speed, engine speed, turn signal status, brake position, vehicle position, steering angle, and ambient temperature. The controller 202 may also control one or more of the vehicle systems 214 based on the sensor data 212, for example, the controller 202 may control a braking system and a steering system to avoid an obstacle based on the calibrated range data. The controller 202 may communicate directly with the vehicle systems 214 or communicate indirectly over a vehicle communication bus, such as a CAN bus 216.

The vehicle system 100 may also communicate with external objects 218, such as remote vehicles and structures, to share the external environment information, such as the calibrated range data, and/or to collect additional external environment information. The vehicle system 100 may include a vehicle-to-everything (V2X) transceiver 220 that is connected to the controller 202 for communicating with the objects 218. For example, the vehicle system 100 may use the V2X transceiver 220 for communicating directly with: a remote vehicle by vehicle-to-vehicle (V2V) communication, a structure (e.g., a sign, a building, or a traffic light) by vehicle-to-infrastructure (V2I) communication, and a motorcycle by vehicle-to-motorcycle (V2M) communication. Each V2X device may provide information indictive of its own status, or the status of another V2X device.

The vehicle system 100 may communicate with a remote computing device 222 over a communications network 224 using one or more of the transceivers 204, 220. For example, the vehicle system 100 may provide data to the remote computing device 222 that is indicative of a message or visual that indicates the location of the objects 218 relative to the AV 106, based on the sensor data 212. The remote computing device 222 may include one or more servers to process one or more processes of the technology described herein. The remote computing device 222 may also communicate data with a database 226 over the network 224.

The vehicle system 100 also communicates with a user interface 228 to provide information to a user of the AV 106. The controller 202 may control the user interface 228 to provide a message or visual that indicates the location of the objects 218, relative to the AV 106, based on the sensor data 212, including the calibrated range data.

Although the controller 202 is described as a single controller, it may contain multiple controllers, or may be embodied as software code within one or more other controllers. The controller 202 includes a processing unit, or processor 230, that may include any number of microprocessors, ASICs, ICs, memory (e.g., FLASH, ROM, RAM, EPROM and/or EEPROM) and software code to co-act with one another to perform a series of operations. Such hardware and/or software may be grouped together in assemblies to perform certain functions. Any one or more of the controllers or devices described herein include computer executable instructions that may be compiled or interpreted from computer programs created using a variety of programming languages and/or technologies. The controller 202 also includes memory 232, or non-transitory computer-readable storage medium, that is capable of executing instructions of a software program. The memory 232 may be, but is not limited to, an electronic storage device, a magnetic storage device, an optical storage device, an electromagnetic storage device, a semi-conductor storage device, or any suitable combination thereof. In general, the processor 230 receives instructions, for example from the memory 232, a computer-readable medium, or the like, and executes the instructions. The controller 202, also includes predetermined data, or “look up tables” that is stored within memory, according to aspects of the disclosure.

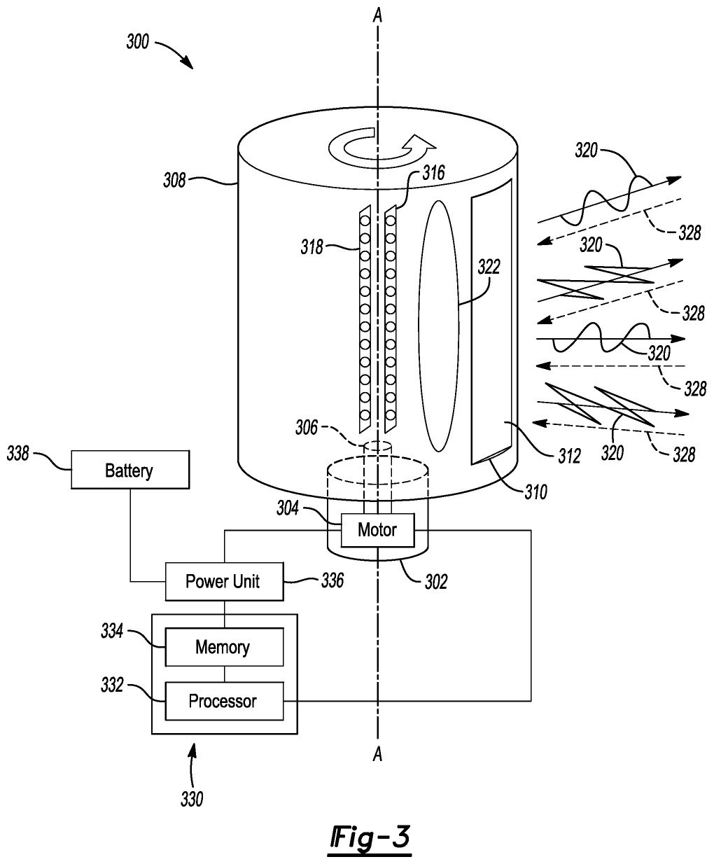

FIG. 3 illustrates an exemplary architecture of a lidar sensor 300, such as the lidar sensor 206 of the top sensor assembly 112, according to aspects of the disclosure. The lidar sensor 300 includes a base 302 that is mounted to the AV 106. The base 302 includes a motor 304 with a shaft 306 that extends along an Axis A-A. The lidar sensor 300 also includes a housing 308 that is secured to the shaft 306 and mounted for rotation relative to the base 302 about Axis A-A. The housing 308 includes an opening 310 and a cover 312 that is secured within the opening 310. The cover 312 is formed of a material that is transparent to light, such as glass. Although a single cover 312 is shown in FIG. 3, the lidar sensor 300 may include multiple covers, or a cover that spans the entire outer surface of the housing 308 (not shown).

The lidar sensor 300 includes one or more emitters 316 for transmitting light pulses 320 through the cover 312 and away from the AV 106. The light pulses 320 are incident on one or more objects and reflect back toward the lidar sensor 300 as reflected light pulses 328. The lidar sensor 300 also includes one or more light detectors 318 for receiving the reflected light pulses 328 that pass through the cover 312. The detectors 318 also receive light from external light sources, such as the sun. The lidar sensor 300 rotates 360 degrees about Axis A-A to scan the region within its FoV. The emitters 316 and the detectors 318 may be stationary, e.g., mounted to the base 302, or dynamic and mounted to the housing 308.

The emitters 316 may include laser emitter chips or other light emitting devices and may include any number of individual emitters (e.g., 8 emitters, 64 emitters, or 128 emitters). The emitters 316 may transmit light pulses 320 of substantially the same intensity or of varying intensities, and in various waveforms, e.g., sinusoidal, square-wave, and sawtooth. The lidar sensor 300 may include one or more optical elements 322 to focus and direct light that is passed through the cover 312.

The detectors 318 may include a photodetector, or an array of photodetectors, that is positioned to receive the reflected light pulses 328. The detectors 318 include a plurality of pixels, wherein each pixel includes a Geiger-mode avalanche photodiode, for detecting reflections of the light pulses during each of a plurality of detection frames, according to aspects of the disclosure. In other embodiments, the detectors 318 include passive imagers.

The lidar sensor 300 includes a controller 330 with a processor 332 and memory 334 to control various components, e.g., the motor 304, the emitters 316, and the detectors 318. The controller 330 also analyzes the data collected by the detectors 318, to measure characteristics of the light received, and generates information about the environment external to the AV 106. The controller 330 may be integrated with another controller, such as the controller 202 of the vehicle system 100. The lidar sensor 300 also includes a power unit 336 that receives electrical power from a vehicle battery 338, and supplies the electrical power to the motor 304, the emitters 316, the detectors 318, and the controller 330.

FIG. 4 depicts a vehicle system 400 for verifying sensor relative alignment in accordance with aspects of the disclosure. In the illustrated embodiment, the vehicle system 400 includes a vehicle sensor 402 with a plurality of motion sensors 404a-404f (“404”) that are mounted to the vehicle sensor 402. In general, the vehicle sensor 402 may be represented by a rigid body, as illustrated in FIG. 4, and may be implemented as a range sensor, such as the camera 210, the lidar sensor 206, and the radar sensor 208. It may be desirable to monitor or measure rotations of the vehicle sensor 402 based on the amount of vibration and/or misalignment that the vehicle sensor 402 experiences when mounted to the AV 106 and particularly when the AV 106 is being driven. Such information may be used to calibrate the vehicle sensor 402 to compensate for misalignment when subjected to vibrations and/or rotations. The vehicle system 400 may determine the relative alignment of the vehicle sensor 402 during a variety of test conditions.

The motion sensors 404 may be implemented as an array of inertial sensors or uni-axial accelerometers that are positioned on the vehicle sensor 402 to capture, for example, various degrees of freedom about the sensor coordinate frame 124 that is located at a center of rotation 408. The center of rotation 408 may be located at a center of mass of the vehicle sensor 402 according to aspects of the disclosure. In general, the degrees of freedom correspond to a number of ways in which the rigid body moves through a three-dimensional space. There are six total degrees of freedom for a three-dimensional object. Three of these degrees of freedom correspond to rotational movement about the X, Y, and Z Axes, which are denoted as Roll, Pitch, and Yaw, respectively, in FIG. 2. Roll refers to the rigid body tilting side to side about the X-Axis. Pitch refers to the rigid body nodding up and down about the Y-Axis; and Yaw refers to the rigid body shaking about the Z-Axis. The other three degrees of freedom correspond to translational movement along these axes, which are denoted as TXs, TYs, and TZs in FIG. 2.

The vehicle system 400 includes an array of at least five motion sensors 404 to capture at least five degrees of freedom, according to aspects of the disclosure. The at least five degrees of freedom include all three rotational degrees of freedom and two of the three translational degrees of freedom. The vehicle system 400 assumes that the rigid body is constrained from translation along the Z-Axis due to the ground, and therefore does not monitor translation along the Z-Axis (TZs) according to aspects of the disclosure.

The vehicle sensor 402 is represented by a cube having a total of six faces (or sides). However, it is recognized that the vehicle sensor 402 may be formed in any number of geometries and the number of sides may vary accordingly. For illustrative purposes, the vehicle sensor 402 as illustrated in FIG. 4 includes a first side 406a that is arranged in an YZ plane, a second side 406b that is arranged in an XZ plane, and a third side 406c that is arranged in an XY plane.

The motion sensors 404a-404e are positioned on the vehicle sensor 402 to identify rotation and translation about five degrees of freedom relative to the three orthogonal Axes (X, Y, Z) of the sensor coordinate frame 124. In order to accomplish this, the alignment of the sensing axes of the motion sensors 404a-404e is arranged such that, when the motion of the vehicle sensor 402 is decomposed along those axes, the motion does not produce a null space. Such a null space would represent rotations of the object that are not measured by the sensors. For example, such a null space occurs when a motion sensor is arranged orthogonal to an axis, or when a pair of motion sensors are arranged symmetrical with each other relative to an axis. Accordingly, a motion sensor arranged non-orthogonally to an axis may capture motion data indicative of a rotational degree of freedom about the axis, as long as the motion sensor is not arranged symmetrically with another motion sensor relative to the axis.

In one example, a total of three motion sensors 404a-404c are positioned on the first side 406a of the vehicle sensor 402 and a total of two motion sensors 404d and 404e are positioned on the second side 406b of the vehicle sensor 402. In general, the three motion sensors 404a-404c that are positioned on the first side 406a of the vehicle sensor 402 provide one translational degree of freedom along the X-Axis (TXs) and two rotational degrees of freedom: Pitch and Yaw. The three motion sensors 404a-404c that are positioned on the first side 406a of the vehicle sensor 402 do not provide Roll because they are positioned symmetrically at equal distances from the X-Axis, and therefore cancel each other out to produce a null space. The two motion sensors 404d-404e that are positioned on the second side 406b of the vehicle sensor 402 provide one translational degree of freedom along the Y-Axis (TYs) and one rotational degrees of freedom: Roll. The vehicle system 400 does not provide data indicative of a translational degree of freedom along the Z-Axis because it does not include motion sensors on the third side 406c of the vehicle sensor 402.

The three motion sensors 404a-404c, as positioned on the first side 406, correspond to a minimum number of motion sensors that are capable of capturing data indicative of two rotational degrees of freedom (Pitch and Yaw) of the vehicle sensor 402. For example, the three motion sensors 404a-404c may be located at three of the four corners of the first side 406a to capture rotations around the Y and Z Axes. In the event only two motion sensors 404a and 404b are positioned on the first side 406, when the vehicle sensor 402 rotates or experiences forces that cause rotational movement, the motion sensors 404a and 404b may not detect the rotation about the Y-Axis (Pitch) if the motion sensors 404a and 404b are positioned symmetrically at equal distances from the Y-Axis and therefore cancel each other out. Similarly, in the event that only two of the motion sensors 404b and 404c are positioned on the first side 406, when the vehicle sensor 402 rotates or experiences forces that cause rotational movement, the motion sensors 404b and 404c may not detect rotation about the Z-Axis (Yaw) if the motion sensors 404b and 404c are positioned symmetrically at equal distances from the Z-Axis and therefore cancel each other out.

As noted above, the three motion sensors 404a-404c that are positioned on the first side 406a may capture two rotational degrees of freedom. The two motion sensors 404d-404e that are positioned on the second side 406b may capture the third rotational degree of freedom: Roll. In this case, the third rotational degree of freedom (Roll) corresponds to the YZ plane that is positioned on the first side 406a that spins relative to the motion sensors 404a-404c.

In general, the motion sensors 404a-404e are uni-axial sensors and therefore measure motion data in one direction only, so that each motion sensor 404a-404e provides a response irrespective of the manner in which the vehicle sensor 402 rotates. As described above, the three motion sensors 404a-404c capture two translational rotations (e.g., Pitch: head nodding of the block, and Yaw: head shaking of the block), since when the vehicle sensor 402 moves in those directions, such motions cause the motion sensors 404a-404c to each provide a response. The motion sensors 404d-404e capture the third rotation which corresponds to Roll: the head tilting to the side.

Therefore, in this regard, by understanding the forces applied to the vehicle sensor 402 using the motion sensors 404a-404e, the vehicle system 400 may ascertain the displacement of the motion sensor 404 when the AV 106 is being driven and calibrate the vehicle sensor 402 to account for misalignment. The controller 202 is operably coupled to each of the motion sensors 404a-404e to receive the motion data from the sensors 404a-404e.

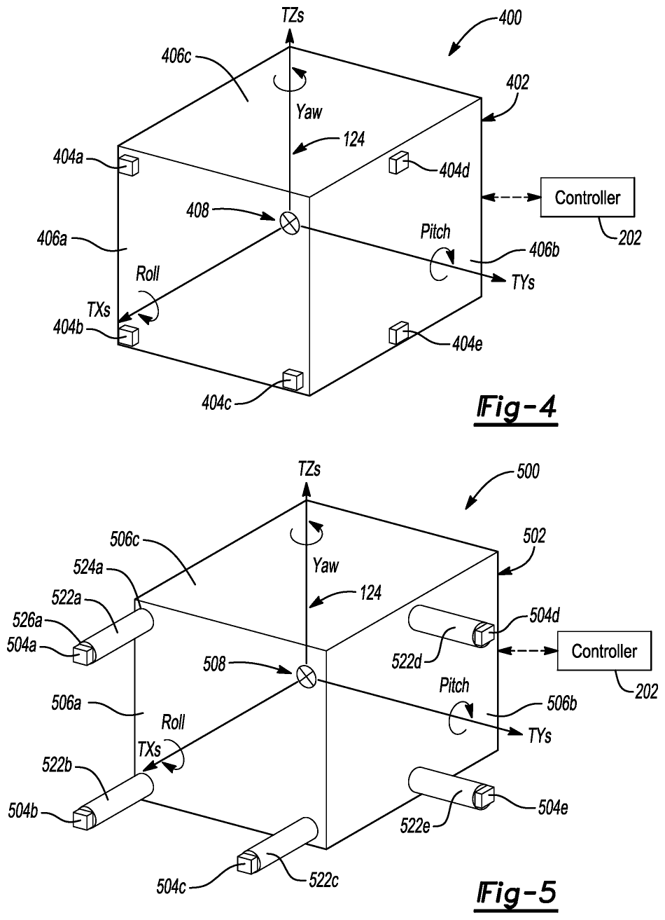

FIG. 5 depicts another vehicle system 500 for verifying sensor relative alignment in accordance with aspects of the disclosure. The vehicle system 500 includes a vehicle sensor 502 and motion sensors 504a-504e, like the vehicle sensor 402, and motion sensors 404a-404e described with reference to the vehicle system 400 of FIG. 4.

The vehicle system 500 also includes a plurality of posts 522a-522e that extend transversely outward from the faces 506a and 506b of the vehicle sensor 502. Each post 522 includes a proximal end 524 mounted to a face 506 and a distal end 526 that is spaced apart from the proximal end 524. Each motion sensor 504a-504e is mounted to the distal end 526 of a corresponding post 522a-522e. For example, the post 522a includes a proximal end 524a that is mounted to the first side 406a, and a distal end 526a that is attached to the motion sensor 504a. The vehicle sensor 502 may be a stationary sensor, such as the camera 210, or a sensor that rotates relative to an axis, such as the lidar sensor 206 of the top sensor assembly 112. For such a rotating lidar sensor, the posts 522a-522e rotate with the vehicle sensor 102 about the Z-Axis while the AV 106 is moving and undergo different levels of acceleration based on the distance the posts 522a-522e are positioned from the center of rotation 508. The controller 202 also determines the rotational displacement of the vehicle sensor 502 while the AV 106 is moving based on the motion data received from the motion sensors 504a-504e.

The posts 522a-522e are used to adjust the natural frequency of the vehicle sensor 502 away from the resonant frequency of the AV 106. Generally, natural frequency refers to the frequency at which a system tends to oscillate in the absence of external forces. If an oscillating system is driven by an external force at a frequency at which the amplitude of its motion is greatest (close to a natural frequency of the system), this frequency is called resonant frequency. If the system is subjected to an external force at its resonant frequency the amplitude of the oscillation increases. If a sensor is mounted to the system, then a signal generated by the sensor during such oscillation would have significant noise resulting in a low signal-to-noise ratio (SNR).

The natural frequency (ω₀) of a mass-spring system, with a mass (m) and spring stiffness (k) may be calculated using Equation 1:

$${ω}_{0} = \sqrt{\frac{k}{m}} \qquad ( 1 )$$

In one example, a vehicle sensor without the posts 522, e.g., the vehicle sensor 402 of FIG. 4, has a natural frequency within the resonant frequency range of the AV 106, therefore the motion sensors 404a-404e provide signals having significant noise resulting in a low SNR.

The posts 522a-522e are designed to increase the natural frequency of the vehicle sensor 502 by at least one octave above the bandwidth of interest. The posts 522a-522e shift the natural frequency of the vehicle sensor 502 away from the resonant frequency of the AV 106 to improve the SNR of the motion data captured by the motion sensors 504a-504e. For example, increasing the stiffness of the posts 522 increases the natural frequency, and increasing mass decreases the natural frequency. The posts 522 are formed of a material that provides high stiffness with low mass, such as aluminum, steel, titanium, ceramic, or structural polymers (ABS, etc.).

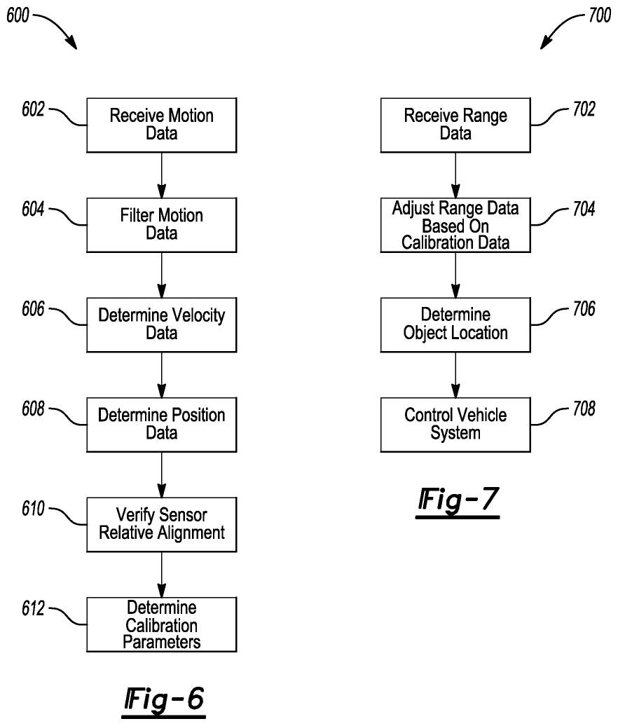

With reference to FIG. 6, a flow chart depicting a method for verifying sensor relative alignment is illustrated in accordance with one or more embodiments and is generally reference by numeral 600. The method 600 is implemented using software code that is executed by the processor 230 and contained within the memory 232 of the controller 202 of the vehicle system 100 according to aspects of the disclosure. Alternatively, the method 600, or portions of the method 600, may be implemented in one or more other controllers, such as the controller 330 of the lidar sensor 300. While the flowchart is illustrated with a number of sequential steps, one or more steps may be omitted and/or executed in another manner without deviating from the scope and contemplation of the present disclosure.

At step 602 the controller 202 receives motion data from the motion sensors 504 that is indicative of the rotational and translational movement of the vehicle sensor 502. The motion sensors 504 are accelerometers that provide acceleration signals that include acceleration data according to aspects of the disclosure.

At step 604 the controller 202 filters the acceleration signal. The filter is implemented as a band pass filter that is centered about a predetermined frequency of interest, according to aspects of the disclosure. The filter may generally eliminate drift associated with the acceleration data provided by the motion sensors 504a-504e. The frequency range of interest is between 5-105 Hz, which corresponds to a low-end of structure borne car road noise frequency, according to aspects of the disclosure.

At step 606, the controller 202 integrates the filtered acceleration signal to obtain a velocity signal. At step 608, the controller 202 integrates the velocity signal to obtain a displacement signal. The controller 202 may perform the integration at steps 606 and 608 in a time or frequency domain. Generally, for both instances of the integration being performed, it may be advantageous to understand the overall velocity and displacement of the vehicle sensor 502 when the AV 106 is in a dynamic state versus when the AV 106 is in a static state. The acceleration signals generally contain low frequency noise and bias (offset from zero). When the signal is integrated, noise at low frequencies is amplified to a higher degree than noise at high frequencies. This is particularly true of zero frequency noise, which is referred to as bias, and which will manifest as a near-constant drift from zero when integrated once. By filtering the signal using a bandpass filter that is centered around a frequency range of interest, the vehicle system 500 can remove lower frequency content that will be amplified during integration, and higher frequency noise.

At step 610 the controller 202 analyzes the displacement data to verify the relative alignment of the vehicle sensor 502. The controller 202 transforms the displacement data from the location of each motion sensor 504 to the sensor coordinate frame 124. Then the controller 202 transforms this data to the vehicle coordinate frame 126 to verify the relative alignment of the vehicle sensor 502. At step 612, the controller 202 then determines calibration parameters for the vehicle sensor 502 to account for any misalignment. The controller 202 uses the calibration parameters to modify range data from the vehicle sensor 502 to improve its performance regarding obstacle detection and avoidance.

With reference to FIG. 7, a flow chart depicting a method for controlling a vehicle system based on range data from a verified sensor is illustrated in accordance with one or more embodiments and is generally reference by numeral 700. The method 700 is implemented using software code that is executed by the processor 230 and contained within the memory 232 of the controller 202 of the vehicle system 100 according to aspects of the disclosure. Alternatively, the method 700, or portions thereof, may be implemented in one or more other controllers, such as the controller 330 of the lidar sensor 300. While the flowchart is illustrated with a number of sequential steps, one or more steps may be omitted and/or executed in another manner without deviating from the scope and contemplation of the present disclosure.

At step 702 the controller 202 receives range data from the vehicle sensor 502. The controller 202 adjusts the range data based on calibration data determined according to the method 600 of FIG. 6 at step 704. The calibration data may be stored in the memory 232 and accessed by the processor 230. At step 706 the controller 202 determines the location of one or more objects in a FoV about the AV 106 based on the calibrated range data. Then at step 708 the controller 202 controls one or more vehicle systems, e.g., a propulsion system, a steering system, or a braking system, to avoid the object.

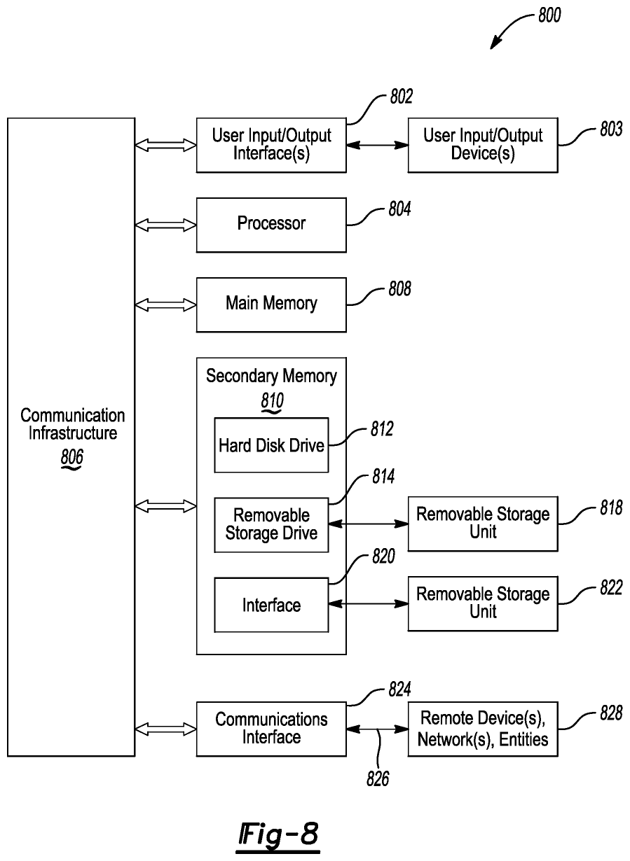

The vehicle system 100 may include one or more controllers, such as the computer system 800 shown in FIG. 8. The computer system 800 may be any computer capable of performing the functions described herein. The computer system 800 also includes user input/output interface(s) 802 and user input/output device(s) 803, such as buttons, monitors, keyboards, pointing devices, etc.

The computer system 800 includes one or more processors (also called central processing units, or CPUs), such as a processor 804. The processor 804 is connected to a communication infrastructure or bus 806. The processor 804 may be a graphics processing unit (GPU), e.g., a specialized electronic circuit designed to process mathematically intensive applications, with a parallel structure for parallel processing large blocks of data, such as mathematically intensive data common to computer graphics applications, images, videos, etc.

The computer system 800 also includes a main memory 808, such as random-access memory (RAM), that includes one or more levels of cache and stored control logic (i.e., computer software) and/or data. The computer system 800 may also include one or more secondary storage devices or secondary memory 810, e.g., a hard disk drive 812; and/or a removable storage device 814 that may interact with a removable storage unit 818. The removable storage device 814 and the removable storage unit 818 may be a floppy disk drive, a magnetic tape drive, a compact disk drive, an optical storage device, tape backup device, and/or any other storage device/drive.

The secondary memory 810 may include other means, instrumentalities or other approaches for allowing computer programs and/or other instructions and/or data to be accessed by computer system 800, e.g., an interface 820 and a removable storage unit 822, e.g., a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computer system 800 may further include a network or communication interface 824 to communicate and interact with any combination of remote devices, remote networks, remote entities, etc. (individually and collectively referenced by reference number 828). For example, the communication interface 824 may allow the computer system 800 to communicate with remote devices 828 over a communication path 826, which may be wired and/or wireless, and which may include any combination of LANs, WANs, the Internet, etc. The control logic and/or data may be transmitted to and from computer system 800 via communication path 826.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, the computer system 800, the main memory 808, the secondary memory 810, and the removable storage units 818 and 822, as well as tangible articles of manufacture embodying any combination of the foregoing. Such control logic, when executed by one or more data processing devices (such as the computer system 800), causes such data processing devices to operate as described herein.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. A “self-driving vehicle” or “autonomous vehicle” is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle. Notably, the present solution is being described herein in the context of an autonomous vehicle. However, the present solution is not limited to autonomous vehicle applications. The present solution may be used in other applications such as an advanced driver assistance system (ADAS), robotic applications, radar system applications, metric applications, and/or system performance applications.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “aspects,” “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other. The breadth and scope of this disclosure should not be limited by any of the above-described exemplary embodiments, but should be defined only in accordance with the following claims and their equivalents.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments.

What is claimed is:

1. A vehicle system comprising:
a sensor with a body, the sensor being configured to capture range data indicative of a distance between the sensor and an object external to a vehicle, the body defining a sensor coordinate frame comprising a first axis, a second axis, and a third axis arranged orthogonally relative to each other;
at least three first motion sensors coupled to the body, each first motion sensor being configured to capture first motion data along a first sensor axis, each first sensor axis being arranged non-orthogonally relative to the first axis and the second axis, wherein the first motion data is indicative of a first rotational degree of freedom about the first axis, and a second rotational degree of freedom about the second axis; and
at least two second motion sensors coupled to the body, each second motion sensor being configured to capture second motion data along a second sensor axis, the second sensor axis being arranged non-orthogonally relative to the third axis, wherein the second motion data is indicative of a third rotational degree of freedom about the third axis.

2. The vehicle system of claim 1, wherein the first sensor axis is arranged non-symmetrically with another first sensor axis relative to the first axis or the second axis.

3. The vehicle system of claim 1, wherein the first sensor axis is arranged in parallel with the third axis such that the first motion data is further indicative of a third translational degree of freedom along the third axis.

4. The vehicle system of claim 1, wherein the second sensor axis is arranged non-symmetrically with another second sensor axis relative to the third axis.

5. The vehicle system of claim 1, wherein the second sensor axis is arranged in parallel with the first axis such that the second motion data is further indicative of a first translational degree of freedom along the first axis.

6. The vehicle system of claim 1 further comprising:
a plurality of posts extending away from the body of the sensor, each post of the plurality of posts comprising a proximal end mounted to the body and a distal end spaced apart from the proximal end, wherein each distal end is configured to receive one or more first motion sensors or second motion sensors.

7. The vehicle system of claim 6 wherein the plurality of posts is configured to increase a natural frequency of the sensor.

8. The vehicle system of claim 6 wherein each post of the plurality of posts is formed of aluminum, steel, titanium, ceramic, or a structural polymer.

9. The vehicle system of claim 1 further comprising a controller configured to:
determine at least one offset to align the sensor coordinate frame with a vehicle coordinate frame based on the first motion data and the second motion data;
determine calibration data for the sensor based on the at least one offset;
adjust the range data based on the calibration data; and
control at least one of a propulsion system, a steering system, and a braking system of the vehicle based on the adjusted range data.

10. The vehicle system of claim 9, wherein the first motion data and the second motion data comprise acceleration data, and wherein the controller is further configured to:
integrate the acceleration data;
generate position data based the integrated acceleration data; and
compare the position data to the vehicle coordinate frame to determine the at least one offset.

11. The vehicle system of claim 10, wherein the controller is further configured to:
filter the acceleration data to remove acceleration data outside of a predetermined frequency range;
integrate the filtered acceleration data; and
generate the position data based the integrated filtered acceleration data.

12. The vehicle system of claim 10, wherein the controller is further configured to:
transform the position data to the sensor coordinate frame; and
compare the transformed position data to the vehicle coordinate frame to determine the at least one offset.

13. A computer implemented method for controlling a vehicle system comprising:
capturing range data, by a sensor, wherein the sensor defines a sensor coordinate frame with a first axis, a second axis, and a third axis arranged orthogonally relative to each other;
capturing first motion data along at least one first sensor axis arranged non-orthogonally relative to the first axis and the second axis;
capturing second motion data along at least one second sensor axis arranged non-orthogonally relative to the third axis;
determining an alignment of the sensor relative to a vehicle coordinate frame based on the first motion data and the second motion data;
determining calibration data for the sensor to align the sensor coordinate frame with the vehicle coordinate frame based on the alignment;
adjusting the range data based on the calibration data; and
controlling at least one of a propulsion system, a steering system, and a braking system of the vehicle based on the adjusted range data.

14. The method of claim 13, wherein the first motion data and the second motion data comprise acceleration data, the method further comprising:
integrating the acceleration data;
generating position data based the integrated acceleration data; and
comparing the position data to the vehicle coordinate frame to determine at least one offset.

15. The method of claim 14 further comprising:
filtering the acceleration data to remove acceleration data outside of a predetermined frequency range;
integrating the filtered acceleration data; and
generating the position data based the integrated filtered acceleration data.

16. The method of claim 14 further comprising:
transforming the position data to the sensor coordinate frame; and
comparing the transformed position data to the vehicle coordinate frame to determine the at least one offset.

17. A non-transitory computer readable medium including computer-executable instructions stored thereon, which when executed by one or more processors, cause the one or more processors to perform operations of:
capturing range data indicative of a distance between a sensor and an object external to a vehicle, wherein the sensor defines a sensor coordinate frame with a first axis, a second axis, and a third axis arranged orthogonally relative to each other;
capturing first motion data along at least one first sensor axis arranged non-orthogonally relative to the first axis and the second axis, wherein the first motion data is indicative of a first rotational degree of freedom about the first axis and of a second rotational degree of freedom about the second axis;
capturing second motion data along at least one second sensor axis arranged non-orthogonally relative to the third axis, wherein the second motion data is indicative of a third rotational degree of freedom about the third axis; and
determining an alignment of the sensor relative to a vehicle coordinate frame based on the first motion data and the second motion data.

18. The non-transitory computer readable medium of claim 17, wherein the computer-executable instructions are further configured to cause the one or more processors to perform operations of:
determining calibration data for the sensor to align the sensor coordinate frame with the vehicle coordinate frame based on the alignment;
adjusting the range data based on the calibration data; and
controlling at least one of a propulsion system, a steering system, and a braking system of the vehicle based on the adjusted range data.

19. The non-transitory computer readable medium of claim 17, wherein the first motion data and the second motion data comprise acceleration data, and wherein the computer-executable instructions are further configured to cause the one or more processors to perform operations of:
integrating the acceleration data;
generating position data based the integrated acceleration data; and
comparing the position data to the vehicle coordinate frame to determine at least one offset.

20. The non-transitory computer readable medium of claim 19, wherein the computer-executable instructions are further configured to cause the one or more processors to perform operations of:
transforming the position data to the sensor coordinate frame; and
comparing the transformed position data to the vehicle coordinate frame to determine the at least one offset.
